(19) United States
(12) Patent Application Publication
(10) Pub. No.: US 2008/0240134 A1
(43) Pub. Date: Oct. 2, 2008

(54) MULTI-NODE, PERIPHERAL COMPONENT SWITCH FOR A COMPUTER SYSTEM

(75) Inventor: Thomas A. Gregg, Highland, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/694,194

(22) Filed: Mar. 30, 2007

(51) Int. Cl. H04L 12/56

(52) U.S. Cl. 370/402

(57) ABSTRACT

Disclosed are a PCI-Express multi-node switch assembly and a computer system including the switch assembly. This switch assembly comprises first and second interconnected PCI-Express switches, each of said switches having first and second primary ports and a plurality of secondary ports. The first primary ports of the switches are adapted to be connected to a host processor unit, and the second primary ports of the switches are connected to each other to transfer signals between the switches. In the preferred embodiment, the first primary ports of the switches are connected to first and second nodes of a host processor unit. The first and second switches receive functional traffic from said first and second node, respectively. Also, the first and second switches are able to receive configuration information from the second and first nodes, respectively, over the interconnection between the switches.

### BACKGROUND OF THE INVENTION

1. Field of the Invention

This invention generally relates to computer systems, and more specifically, the invention relates to switches that link peripheral components to a host of a computer system. Even more specifically, the preferred embodiment of the invention relates to such switches of the type referred to as PCI Express or PCI Express compatible.

2. Background Art

Today's computing platforms and processing systems are moving toward an I/O interconnect topology that provides a single communication path between each peripheral device and the host. These computing platforms and processing systems may use packetized communications for communicating between the switching elements within the tree structure. Examples of such computing platforms and processing systems include what is referred to as, for example, peripheral component interconnect (PCI) systems and PCI Express systems. Peripheral devices are discovered by such platforms and systems through an enumeration process performed by a host system element.

A PCI Express compatible switch with multiple ports appears to PCI compatible enumeration and configuration software as a two level hierarchy of PCI-to-PCI bridges. Each switch port appears to the configuration software as a distinct PCI-to-PCI bridge. Each port can support up to eight sub-functions, each sub-function potentially introducing a linked list of supported capabilities. Among the ports, there is an upstream port. The upstream port, which appears to software as a PCI-to-PCI bridge, is the only port through which PCI compatible software can read and/or write the internal configuration registers of the switch. All other ports of the switch, referred to as downstream ports, appear as distinct PCI-to-PCI bridges to the configuration software. As a result, a two-level hierarchy of PCI-to-PCI bridges is formed.

PCI-Express is quickly becoming the standard I/O expansion network. However, its tree structure lacks the ability to have more than one connection to a root complex. Dual path capability for concurrent node repair needs to be added to switches and firmware.

### SUMMARY OF THE INVENTION

An object of this invention is to provide a peripheral component switch of a computer system with dual path capability for concurrent node repairs.

Another object of the present invention is to provide a peripheral component switch of a computer system with two or more north facing capable ports, both connected to a host of the computer system through different root complexes.

A further object of the invention is to provide a plural-path peripheral component switch of a computer system that operates in a transparent mode, meaning that there is a flat address space and the switch does not translate or modify the addresses.

These and other objectives are attained with a PCI-Express multi-node switch assembly and a computer system including the switch assembly. This switch assembly comprises first and second interconnected PCI-Express switches, each of said switches having first and second primary ports and a plurality of secondary ports. The first primary ports of the switches are adapted to be connected to a host processor unit, and the second primary ports of the switches are connected to each other to transfer signals between the switches.

In the preferred embodiment, the first primary ports of the switches are adapted to be connected to first and second nodes of a host processor unit. The first primary port of the first switch receives functional traffic from said first node, and the first primary port of the second switch receives functional traffic from said second node. The second switch receives configuration information from the first node over the interconnection between the switches; and the first switch receives configuration information from the second node over the interconnection between the switches. Also, in this preferred embodiment, each of the switches operates in a plurality of modes, and said configuration information includes commands to place said switches in said modes. For example, these modes may include a normal mode and a takeover mode.

By creating a PCI-Express switch with two (or more) north facing capable ports, both connected to the host through different root complexes (intervening switches are allowed), one port may be operated as the standard PCI-Express north facing port for data transfer while the second (or other) port may be operated in a standby mode. This second port communicates “configuration” information to the host. The second north facing port may take over the normal data transfer when instructed to do so by commands received from the host to either of the north facing ports. Pairs (or more) of these special switches can be interconnected, in which case the second north facing port becomes a south facing port upon takeover.

The preferred embodiment of the invention, described below in detail, provides a number of important advantages. For example, one significant advantage is that, in this preferred embodiment, the multi-paths, with or without switches, operate in a transparent mode, meaning that there is a flat address space, and the switches do not translate or modify the addresses. “Transparency” preserves the checking power of the end-to-end CRC (ECRC).

Further benefits and advantages of this invention will become apparent from a consideration of the following detailed description, given with reference to the accompanying drawings, which specify and show preferred embodiments of the invention.

### BRIEF DESCRIPTION OF THE DRAWINGS

FIG. 1 is a general block diagram of a computer system incorporating the switches of the present invention.

FIG. 2 is a more detailed diagram of a multi node switch of this invention.

FIG. 3 is a more detailed diagram of a computer system that uses the switch of this invention.

FIG. 4 shows a pair of switches embodying this invention and connected together in a normal mode.

FIGS. 5 and 6 illustrate address routing and requestor/completer ID routing in the switches of FIG. 4.

FIG. 7 shows the switches of FIG. 4 in master takeover and slave takeover modes.

FIGS. 8 and 9 show address routing and requestor/completer ID routing in the switches of FIG. 7.

### DETAILED DESCRIPTION OF THE PREFERRED EMBODIMENTS

The following description and the drawings illustrate specific embodiments of the invention sufficiently to enable those skilled in the art to practice it. Other embodiments may incorporate structural, logical, electrical, process, and other changes. Examples merely typify possible variations.

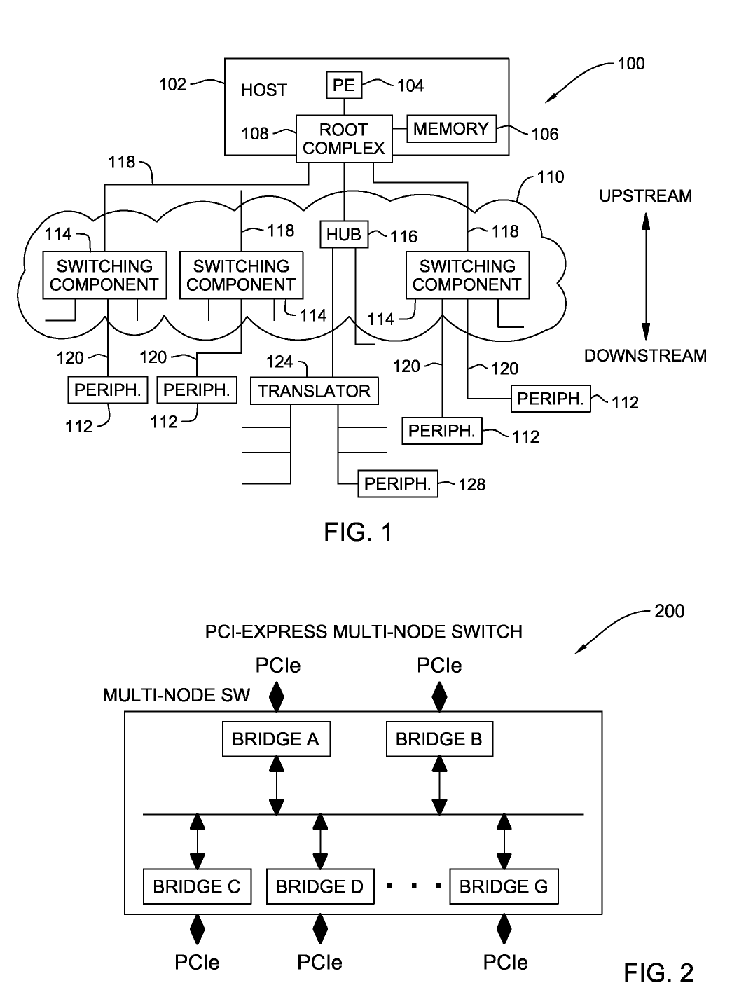

FIG. 1 is a block diagram of a system having an I/O interconnect topology in accordance with an embodiment of the present invention. System 100 may be any computing platform or processing system having an I/O interconnect topology as illustrated, and may utilize packetized communications for internal communications between elements. System 100 may comprise host 102, which may include one or more processing elements (PEs) 104, memory 106 and root complex 108. System 100 may also comprise switching fabric 110 to route packetized communications between root complex and peripheral devices 112. Switching fabric 110 includes one or more switching elements 114 to provide the switching functionality, and may optionally include one or more hubs 116. Switching elements 114 may provide switching functionality in accordance with PCI Express systems.

Communication paths 118 couple root complex 108 with switching elements 114, while communication paths 120 couple switching elements 114 with peripheral devices 112. Communication paths 118 and 120 may provide duplex communications over a physical communication path, and may comprise buses, although this is not a requirement. Although only three switching elements 114 are illustrated in FIG. 1, a system may include many hundred switching elements or more. Translator 124 provides for communications with several peripherals 128 through hub 116.

As used herein, the term “downstream” may be used to refer to communications in the direction from host 102 to peripheral devices 112, while the term “upstream” may be used to refer to communications in the direction from peripheral devices 112 to host 102. Also, although system 100 is illustrated as having several separate elements, one or more of the elements may be combined and may be implemented by combinations of software-configured elements, such as processors including digital signal processors (DSPs), and/or other hardware elements.

FIG. 2 illustrates a switching element 200 in accordance with the present invention, and more specifically, this switching element is a PCI-Express Multi-Node Switch. Switching element includes a pair of primary, or “north,” ports A and B, and a series of secondary, or “south,” ports C-G. These ports are connected together by a group of buses, as shown in FIG. 2.

Switching element 200 has a number of applications, including a single host, multi-path application; a multi-host, storage application; a double barrel application; and an automatic failover application.

The single host, multi-path application has two modes: a normal mode, and a controlled swap (failed-over) mode. In the normal mode, one primary port owns all secondary ports, and the other primary port is available for minimum access to internal registers. Commands can be routed to/from the active primary port to the inactive primary port.

In the controlled swap (failed-over) mode, one primary port owns all secondary ports, and the second primary port operates as a secondary port. In the double barrel application, two parallel signal paths are provided through the switch. In the automatic failover application, multiple paths are provided from an end point to a host hub. Also, in this automatic failover application, multiple switching elements may be connected together in a ring structure.

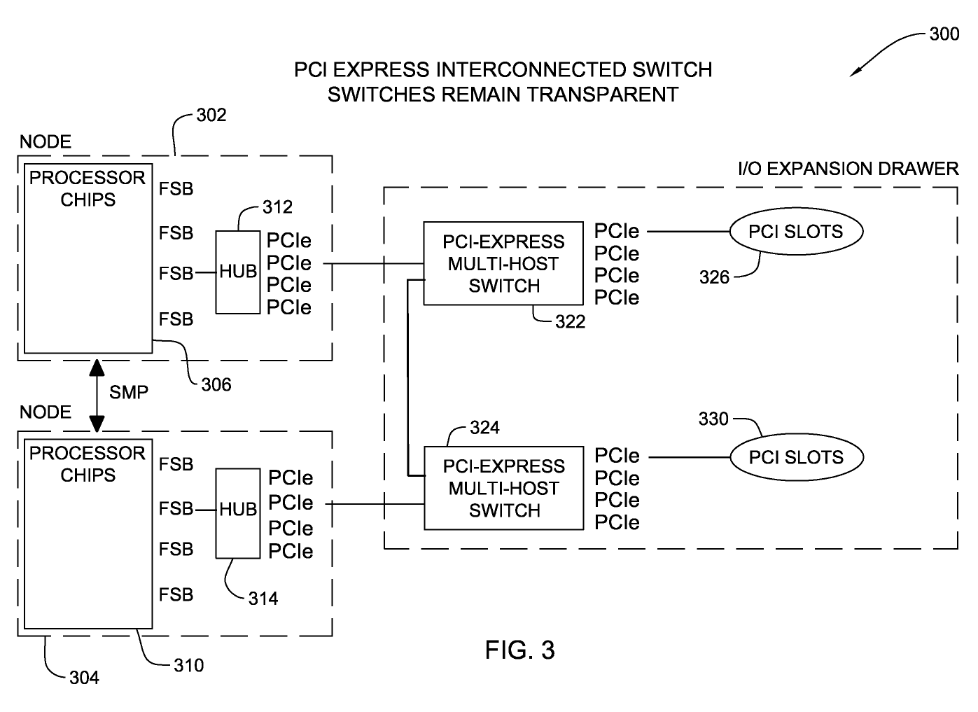

FIG. 3 illustrates, in more detail, a computer system 300 in which switching element 200 is used. System 300 includes a pair of nodes 302 and 304, each of which includes a group of processor chips 306, 310 and a conventional or standard hub 312, 314. Node 302 is connected to switching element 322, and node 304 is connected to switching element 324. Switching element 322, in turn, is connected to PCI slots 326, and switching element 324 is connected to PCI slots 330.

Each of the switching elements 322, 324, may be designed as shown at 200 in FIG. 2. As will be understood by those of ordinary skill in the art, system 300 may include additional or alternate items not specifically discussed herein. It may also be noted that the example switching elements of FIG. 3 shows two north-facing ports and two south facing ports, but more south facing ports may be implemented.

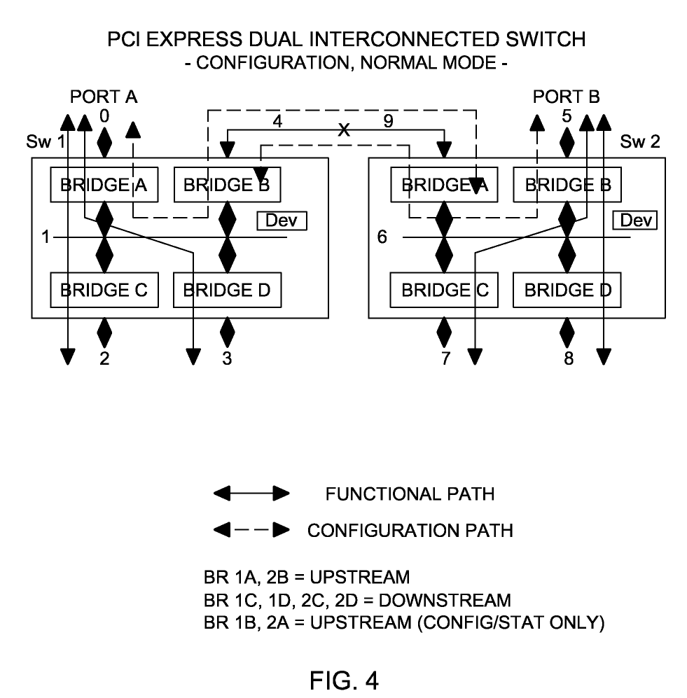

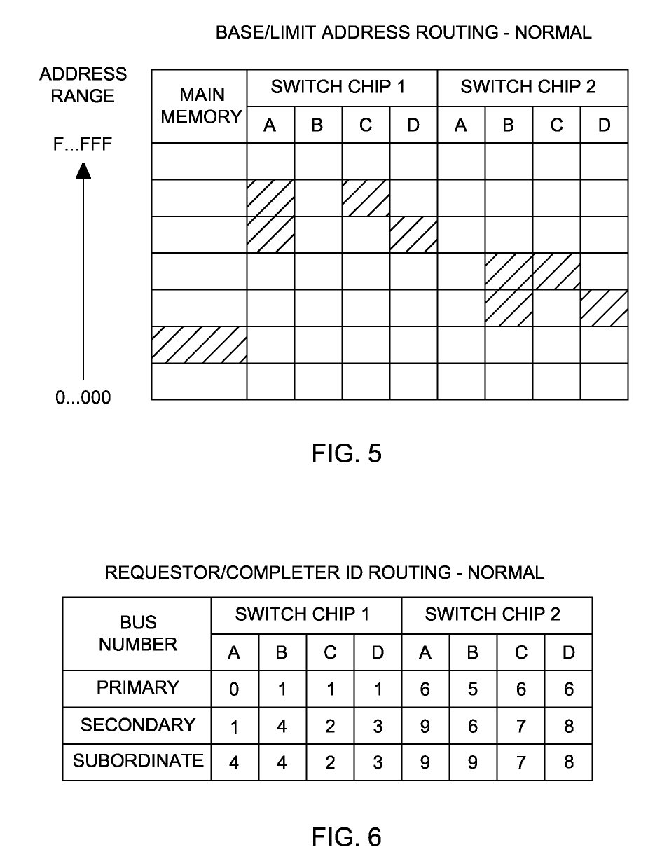

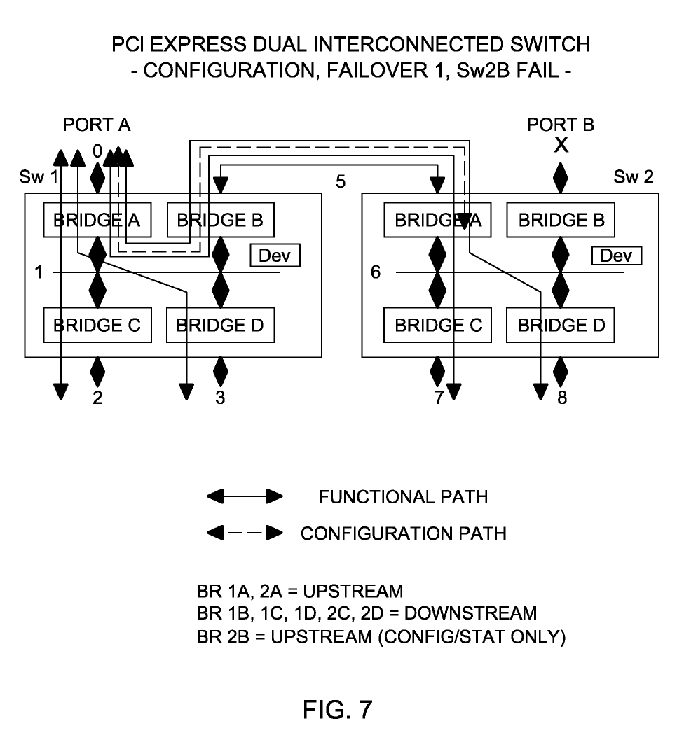

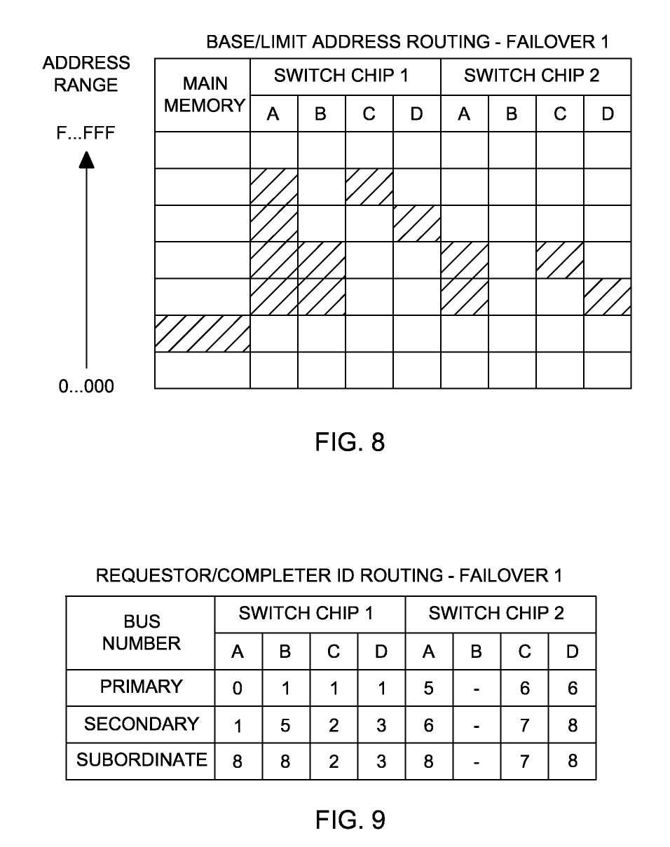

Switches 322, 324 may operate in a number of modes, including a normal mode, a master takeover mode, and a slave takeover mode. FIG. 4 shows a pair of the switches, referred to in FIG. 4 as switch 1 and switch 2, in the normal mode. FIG. 7 shows switches 1 and 2 in the takeover mode, with switch 1 being in the master takeover mode and switch 2 being in the slave takeover mode. For PCIe Bridges in a plural path environment, the PCIe routing mechanisms for both Requester ID routing and address routing are extended to control the multiple modes, one for the normal mode and additional tables for the takeover modes. During the takeover process, firmware/software performs the controlled takeover and updates the routing tables from the values shown in FIGS. 5 and 6 to the values shown in FIGS. 8 and 9. Likewise, there is a similar pair of routing tables (not shown) for the controlled takeover mode when Port A is disabled.

With reference to FIG. 4, in the normal mode, switches 1 and 2 operate largely independently. PCIe bus 0 handles functional traffic for buses 2 and 3, and PCIe bus 5 handles functional traffic for buses 7 and 8. The functional traffic is routed by the standard base/limit address and Requester/Completer ID routing. Switches 1 and 2 are also interconnected over PCIe bus 4/9. This bus may use a single bus number rather than two, but to make it more symmetrical and easier to illustrate, two bus numbers have been assigned. Node A can write configuration and read status information to switch 2 over PCIe bus 4, and Node B can do the same to switch 1 over PCIe bus 9. The key piece of configuration information in each switch is to tell it which of three modes in which it needs to operate. One mode is the Normal mode, described above, and the other modes are the master takeover mode and the slave takeover mode.

As mentioned above, FIG. 7 shows the switches in the master takeover and slave takeover modes. Switch 1 in FIG. 7 is in the Master Takeover mode and switch 2 is in the Slave Takeover mode. In Takeover mode, switches 1 and 2 are cascaded. Switch 1 (in Master Takeover mode) looks like a normal PCI-Express defined switch with one north facing bus (bus 0) and three south facing buses (buses 2, 3, and 5). Switch 2 (in Slave Takeover mode) looks almost like a normal PCI-Express defined switch with one north facing bus (bus 5 connected to switch 1) and two south facing buses (buses 7 and 8). Switch 2, Bridge B is in an “offline” state, but it can still receive configuration and return status information from/to Node B. Bus number 4 could be assigned as the primary bus number.

During a controlled takeover and the return to normal operation, software/firmware is responsible for quiescing all functional traffic through the switches in both the upstream and downstream directions, changing the operational modes of each switch, changing the Address and Requester ID Routing registers as appropriate, and restarting the functional traffic. The controls are accessed through PCI Devices in each switch.

The preferred embodiment of the invention, described above in detail, has a number of important advantages. One important advantage, for example, is that the multi-paths, with or without switches, operate in a transparent mode, meaning that there is a flat address space, and the switches do not translate or modify the addresses.

The PCIe packets pass through the switches unaltered, especially the memory addresses and Requester IDs in the packets. Transparent switches have the reliability and error detection advantage by preserving the End-to-End CRC from end point to end point. This is in contrast to non-transparent switches where memory address, Requester IDs, and other fields in the packets may be translated or altered. These alterations to the packet headers required the switches to recalculate the End-to-End CRC, and this recalculation makes the system more susceptible to undetected switch generated errors.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A PCI-Express multi-node switch assembly, comprising:
first and second interconnected PCI-Express switches, each of said switches having first and second primary ports and a plurality of secondary ports, and wherein:
the first primary ports of the switches are adapted to be connected to a host processor unit; and
the second primary ports of the switches are connected to each other to transfer signals between the switches.

2. A PCI-Express multi-node switch assembly according to claim 1, wherein the first primary ports of the switches are adapted to be connected to first and second nodes of a host processor unit.

3. A PCI-Express multi-node switch assembly according to claim 2, wherein:
the first primary port of the first switch receives functional traffic from said first node;
the first primary port of the second switch receives functional traffic from said second node; and
the second switch receives configuration information from the first node over the interconnection between the switches; and
the first switch receives configuration information from the second node over the interconnection between the switches.

4. A PCI-Express multi-node switch assembly according to claim 3, wherein each of the switches operates in a plurality of modes, and said configuration information includes commands to place said switches in said modes.

5. A PCI-Express multi-node switch assembly according to claim 4, wherein said modes includes a normal mode and a takeover mode.

6. A PCI-Express multi-node switch assembly according to claim 5, wherein in said takeover mode, the first and second switches are cascaded, via the interconnection between the switches, and operate in series.

7. A computer system, comprising:
a host processor unit;
a plurality of peripheral devices; and
a plurality of signal paths connecting the peripheral devices to the host processor unit, said plurality of signal paths including at least one pair of interconnected switches, each of the switches having first and second primary ports and a plurality of secondary ports, and wherein one of the primary ports of each of the switches is connected to the host processor unit, and the other primary ports of the switches are connected to each other.

8. A computer system according to claim 7, wherein:
the host processor unit includes Node A and Node B; and
the primary port of a first of the pair of switches is connected to Node A, and the primary port of the second of said pair of switches is connected to Node B.

9. A computer system according to claim 8, wherein:
functional traffic is routed from Node A to said first switch over the primary port of said first switch;
functional traffic is routed from Node B to said second switch over the primary port of said second switch;
Node A writes and reads configuration information to the second switch over the interconnection between the first and second switches; and
Node B writes and reads configuration information to the first switch over the interconnection between the first and second switches.

10. A computer system according to claim 9, wherein:
each of the switches operates in a plurality of nodes; and
said configuration information includes commands to place said switches in said modes.

11. A computer system according to claim 10, wherein said modes includes a normal mode and a takeover mode.

12. A computer system according to claim 11, wherein in said takeover mode, the first and second switches are cascaded and operate in series.

13. A method of operating a pair of PCI-Express switches, wherein each of said switches has first and second primary ports and a plurality of secondary ports, the first primary ports of the switches are adapted to be connected to a host processor unit, and the second primary ports of the switches are connected to each other, said method comprising the steps of:
transferring signals from a first of the switches to the second of the switches over the interconnection between the switches; and
transferring signals from the second of the switches to the first of the switches over the interconnection between the switches.

14. A method according to claim 13, wherein the first primary ports of the switches are connected to first and second nodes of the host processor unit.

15. A method according to claim 14, comprising the further steps of:
sending functional traffic from said first node to the first primary port of the first switch;
sending functional traffic from said second node to the first primary port of the second switch;
sending configuration information from the first node to the second switch over the interconnection between the switches; and
sending configuration information from the second node to the first switch over the interconnection between the switches.

16. A method according to claim 15, wherein each of the switches operates in a plurality of nodes, and said configuration information includes commands to place said switches in said modes.

17. A method according to claim 16, wherein said modes includes a normal mode and a takeover mode.

18. A method according to claim 17, wherein in said takeover mode, the first and second switches are cascaded, via the interconnection between the switches, and operate in series.
